(19) United States
(12) Patent Application Publication
(10) Pub. No.: US 2010/0260297 A1
(43) Pub. Date: Oct. 14, 2010

(54) APPARATUS AND METHOD FOR DETERMINING PHASE DIFFERENCE INFORMATION BETWEEN TWO SIGNALS

(76) Inventors: Yen-Horng Chen, Taipei City (TW); Chih-Chun Tang, Taipei City (TW)

Correspondence Address: NORTH AMERICA INTELLECTUAL PROPERTY CORPORATION, P.O. BOX 506, MERRIFIELD, VA, 22116, US

(21) Appl. No.: 12/420,826

(22) Filed: Apr. 9, 2009

(51) Int. Cl. H04L 7/04

(52) U.S. Cl. 375/362

(57) ABSTRACT

An apparatus for determining phase difference information between a first signal and a second signal includes a first detector, a second detector and a counter. The first detector is used for detecting a first value of the first signal, the second detector is used for detecting a second value of the second signal, and the counter is used for counting a timing when the first signal is at the first value and a timing when the second signal is at the second value with a reference clock signal to generate a counter value which serves as a basis of the phase difference information.

### BACKGROUND

The present invention relates to apparatus and methods for determining phase difference information between two signals, and more particularly, to apparatus and methods for determining phase difference information between two signals by a counter.

A radio communication receiver generally has two channels, respectively known as an I-channel and a Q-channel, which mixes a received signal with local oscillation signals to generate an in-phase signal (I signal) and a quadrature signal (Q signal), respectively. The I and Q signals are filtered and gain adjusted and finally sent to a digital signal processing circuit to extract the communicated data.

Phase difference between I and Q signals should ideally be 90 degrees. However, it is hard to have ideal quadrature LO signal because of the device and parasitic mismatch in high frequency quadrature LO generator (i.e., the divider), which results in phase mismatch between the I and Q signals, making the digital signal processing circuit unable to extract the communicated data correctly.

### SUMMARY

According to one embodiment of the present invention, an apparatus for determining phase difference information between a first signal and a second signal comprises a first detector, a second detector and a counter. The first detector is used for detecting a first value of the first signal, the second detector is used for detecting a second value of the second signal, and the counter is used for counting a timing when the first signal is at the first value and a timing when the second signal is at the second value with a reference clock signal to generate a counter value which serves as a basis of the phase difference information.

According to another embodiment of the present invention, a method for determining phase difference information between a first signal and a second signal comprises: detecting a first value of the first signal; detecting a second value of the second signal; and generating a counter value which serves as a basis of the phase difference information by counting a timing when the first signal is at the first value and a timing when the second signal is at the second value with a reference clock signal.

According to another embodiment of the present invention, an apparatus for determining phase difference information between a first signal and a second signal comprises a first detector and a second detector. The first detector is used for detecting a first value of the first signal, and after a predetermined time following a timing when the first detector detects the first value of the first signal, the second detector is arranged to detect a value of the second signal to serve as a basis of the phase difference information.

According to another embodiment of the present invention, a method for determining phase difference information between a first signal and a second signal comprises: detecting a first value of the first signal; and after a predetermined time following a timing when detecting the first value of the first signal, detecting a value of the second signal to serve as a basis of the phase difference information.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1A is a radio communication receiver according to a first embodiment of the present invention.

FIG. 1B is a radio communication receiver according to a second embodiment of the present invention.

FIG. 2 is an auxiliary diagram for explaining a determination of the phase difference information between the digitized I signal and the digitized Q signal shown in FIG. 1A.

FIG. 3A is a radio communication receiver according to a third embodiment of the present invention.

FIG. 3B is a radio communication receiver according to a fourth embodiment of the present invention.

FIG. 4 is an auxiliary diagram for explaining a determination of the phase difference information between the digitized I signal and the digitized Q signal shown in FIG. 3A.

FIG. 5 is a simplified flowchart of determining phase difference information between a first signal and a second signal according to one embodiment of the present invention.

FIG. 6 is a simplified flowchart of determining phase difference information between a first signal and a second signal according to another embodiment of the present invention.

### DETAILED DESCRIPTION

Certain terms are used throughout the following description and claims to refer to particular system components. As one skilled in the art will appreciate, manufacturers may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ” The terms “couple” and “couples” are intended to mean either an indirect or a direct electrical connection. Thus, if a first device couples to a second device, that connection may be through a direct electrical connection, or through an indirect electrical connection via other devices and connections.

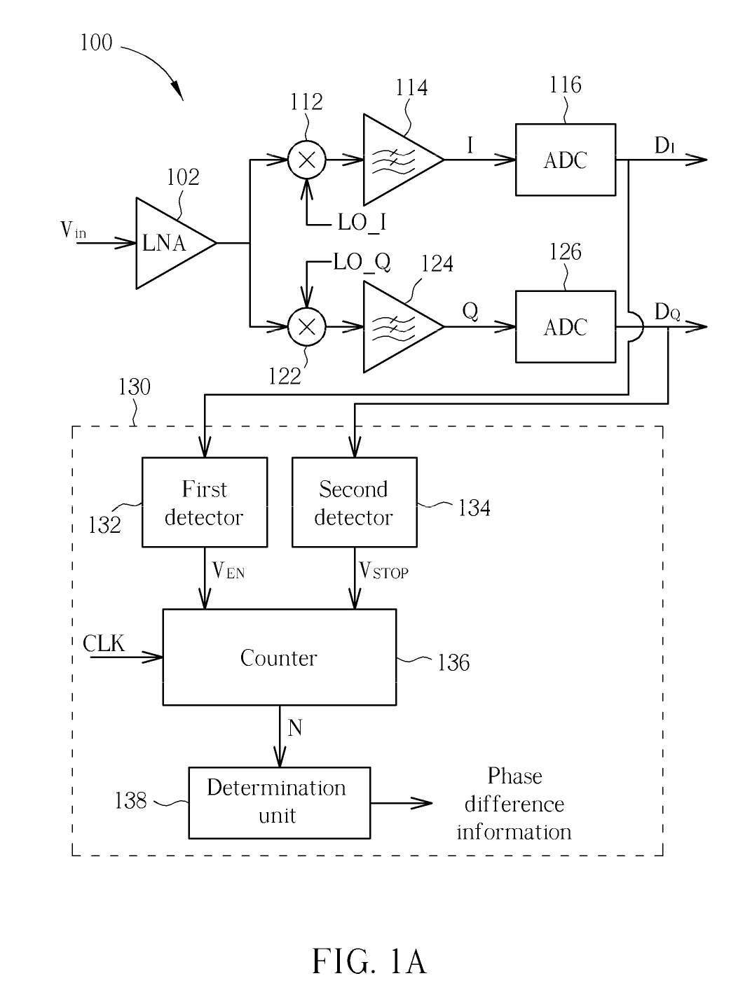

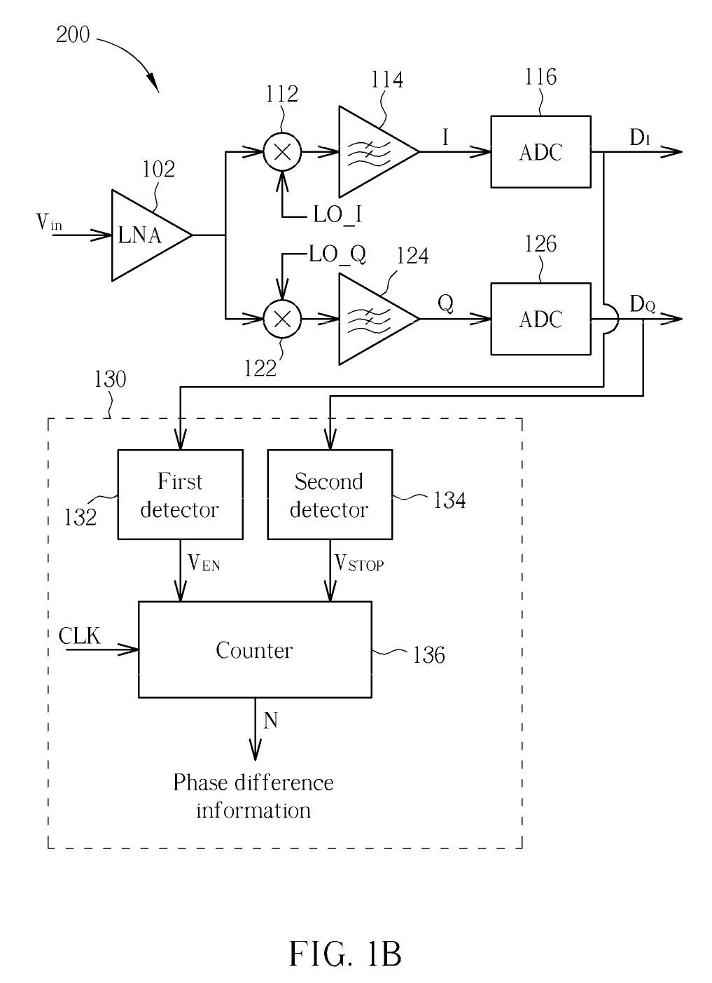

Please refer to FIG. 1A. FIG. 1A is a communication receiver 100 according to a first embodiment of the present invention. The communication receiver 100 includes a low-noise amplifier (LNA) 102, two mixers 112 and 122, two filters 114 and 124, two analog-to-digital converters (ADC) 116 and 126, and an apparatus 130 for determining phase difference information between I and Q signals, where the apparatus 130 includes a first detector 132, a second detector 134, a counter 136 and a determination unit 138. In this embodiment, the mixer 112, the filter 114 and the ADC 116 serve as a part of an I-channel, and the mixer 122, the filter 124 and the ADC 126 serve as a part of a Q-channel.

In the operations of the communication receiver 100, an input signal Vᵢₙ is inputted into the LNA 102 to generate an amplified input signal, then, the amplified input signal is inputted into the mixers 112 and 122. In the I-channel, the mixer 112 mixes the amplified input signal with a first local oscillation signal LO_1 to generate an in-phase signal (I signal), and the filter 114 filters the I signal to generate a filtered I signal, and the ADC 116 executes an analog-to-digital conversion operation upon the filtered I signal to generate a digitized I signal D_{I}. Similarly, in the Q-channel, the mixer 122 mixes the amplified input signal with a second local oscillation signal LO_Q to generate a quadrature signal (Q signal), and the filter 124 filters the Q signal to generate a filtered Q signal, and the ADC 126 executes an analog-to-digital conversion operation upon the filtered Q signal to generate a digitized Q signal D_{Q}.

It is hard to have ideal quadrature LO signal LO_Q because of the device and parasitic mismatch in high frequency quadrature LO generator, and the phase difference between the digitized I signal D_{I} and the digitized Q signal D_{Q} will not be 90 degrees. As this situation may result in errors in the following digital processing circuits, a specific criterion (for example, e.g., the phase difference being within a range 85°-95°) is provided to judge if the phase difference between the digitized I signal D_{I} and the digitized Q signal D_{Q} will possibly cause errors in the following digital processing. The apparatus 130 shown in FIG. 1A is used to determine if the phase difference between the digitized I signal D_{I} and the digitized Q signal D_{Q} meets this exemplary specific criterion.

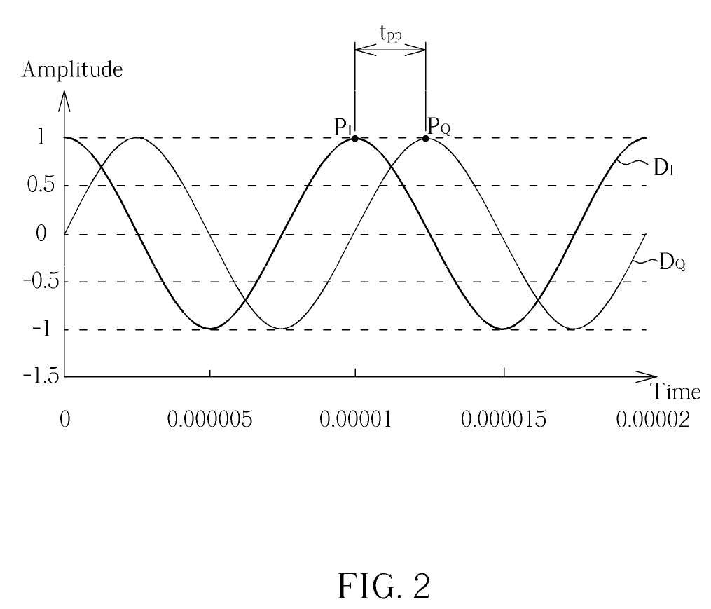

Regarding the operations of the apparatus 130, please refer to FIG. 1A and FIG. 2 together. FIG. 2 is an auxiliary diagram for explaining a determination of the phase difference information between the digitized I signal D_{I} and the digitized Q signal D_{Q} shown in FIG. 1A. The first detector 132 receives and detects a peak P_{I} of the digitized I signal D_{I}, and when the peak P_{I} is detected, the first detector 132 sends an enable signal V_{EN} to enable the counter 136 to start using a reference clock CLK to count a timing. Then, the second detector 134 receives and detects a peak P_{Q} of the digitized I signal D_{Q}, and when the peak P_{Q} is detected, the second detector 134 sends a stop signal V_{STOP} to make the counter 136 stop counting. At this time, the counter 136 generates a counter value N which represents a number of cycles of the reference clock CLK during a timing between the peak P_{I} and the peak P_{Q}, in other words, the counter value N represents a timing difference t_{PP} between the peaks P_{I} and P_{Q}. Finally, the determination unit 138 receives the counter value N and determines whether a phase difference between the digitized I signal D_{I} and the digitized Q signal D_{Q} meets the exemplary specific criterion, for example, by checking if the counter value is within a predetermined range, and thereby generates the phase difference information. In addition, when the counter value N is within the predetermined range, the phase difference information indicates that the phase difference between the digitized I signal D_{I} and the digitized Q signal D_{Q} meets the criterion; and when the counter value N is out of the predetermined range, the phase difference information indicates that the phase difference between the digitized I signal D_{I} and the digitized Q signal D_{Q} does not meet the criterion.

It is noted that, in the communication receiver 100 shown in FIG. 1A, the apparatus 130 determines whether the phase difference between the digitized I signal D_{I} and the digitized Q signal D_{Q} meets a specific criterion. In other embodiments of the present invention, the apparatus 130 can alternatively receive other I and Q signals from the I-channel and the Q-channel before the ADCs 116 and 126, such as the filtered I signal outputted from the filter 114 and the filtered Q signal outputted from the filter 124, to determine phase difference information indicative of a phase difference between two analog signals, e.g., the filtered I and Q signals.

In addition, in a second embodiment of the present invention as shown in FIG. 1B, the counter value N can directly serve as the phase difference information which is determined by the apparatus 130. That is, the determination unit 138 can be removed from the apparatus 130 without influencing the operations of the apparatus 130. The components of a communication receiver 200 and the communication receiver 100 with the same symbols have the same functions. A person skilled in this art can understand the operations of the communication receiver 200 shown in FIG. 1B, and the descriptions of the operations of the communication receiver 200 are therefore omitted here.

In addition, in the apparatus 130, the first detector 132 is used to detect the peak P_{I} of the digitized I signal D_{I} and the second detector 134 is used to detect the peak P_{Q} of the digitized Q signal D_{Q}. However, the detected target of the detectors 132 and 134 is not limited to the peak as illustrated in this embodiment, that is, other detectable values of the communicated signal, such as the zero crossing point or the point of a half amplitude, could be selected as the target the detectors 132 and 134 designed to detect. In other embodiments of the present invention, the first detector 132 can detect a first value of the digitized I signal D_{I} and the second detector 134 can detect a second value of the digitized Q signal D_{Q}, where the first and the second values may or may not be the same. For example, the first and the second values can be the zero crossing points of the digitized I signal D_{I} and the digitized Q signal D_{Q}, respectively.

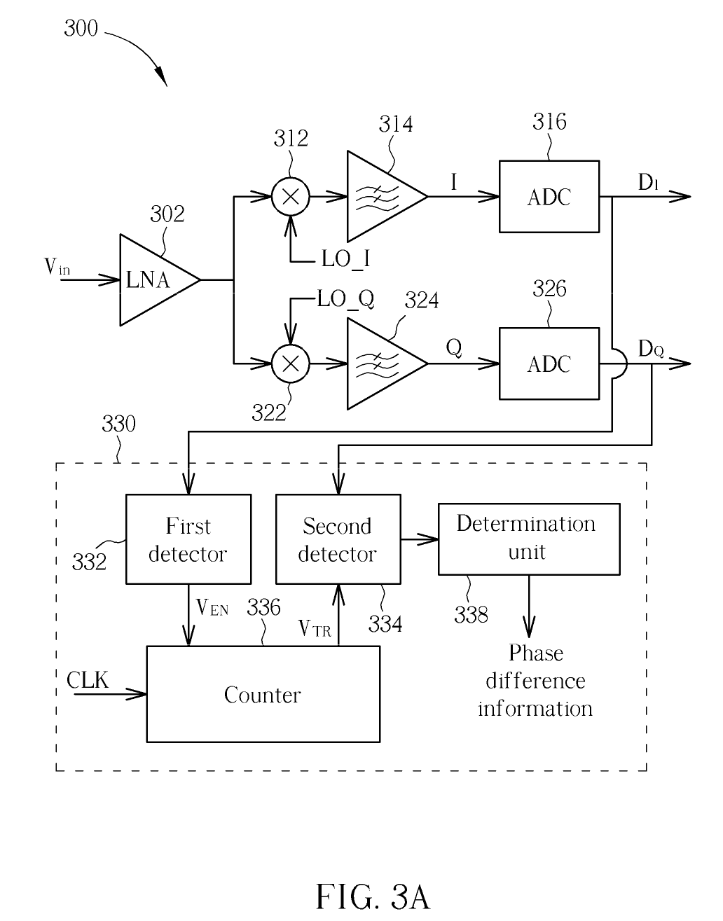

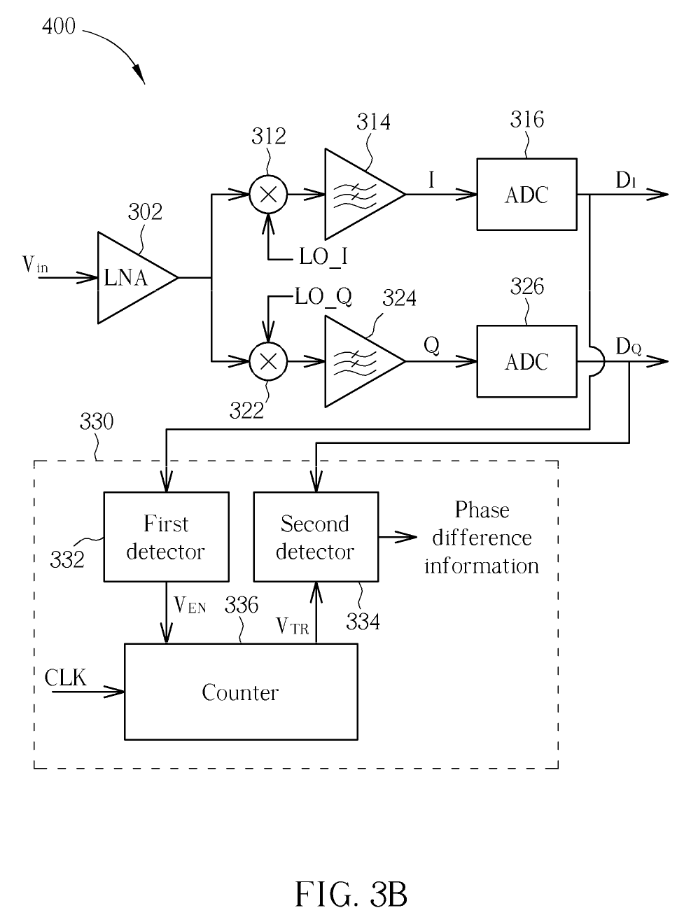

Please refer to FIG. 3A. FIG. 3A is a diagram illustrating a communication receiver 300 according to a third embodiment of the present invention. The communication receiver 300 includes a low-noise amplifier 302, two mixers 312 and 322, two filters 314 and 324, two analog-to-digital converters (ADC) 316 and 326, and an apparatus 330 for determining phase difference information between I and Q signals, where the apparatus 330 includes a first detector 332, a second detector 334, a counter 336 and a determination unit 338. In this embodiment, the mixer 312, the filter 314 and the ADC 316 serve as a part of an I-channel, and the mixer 322, the filter 324 and the ADC 326 serve as a part of a Q-channel.

In the operations of the communication receiver 300, first, an input signal Vᵢₙ is inputted into the LNA 302 to generate an amplified input signal, then, the amplified input signal is inputted into the mixers 312 and 322. In the I-channel, the mixer 312 mixes the amplified input signal with a first local oscillation signal LO_I to generate an in-phase signal (I signal), and the filter 314 filters the I signal to generate a filtered I signal, and the ADC 316 executes an analog-to-digital conversion operation upon the filtered I signal to generate a digitized I signal D_{I}. Similarly, in the Q-channel, the mixer 322 mixes the amplified input signal with a second local oscillation signal LO_Q to generate a quadrature signal (Q signal), and the filter 324 filters the Q signal to generate a filtered Q signal, and the ADC 326 executes an analog-to-digital conversion operation upon the filtered Q signal to generate a digitized Q signal D_{Q}.

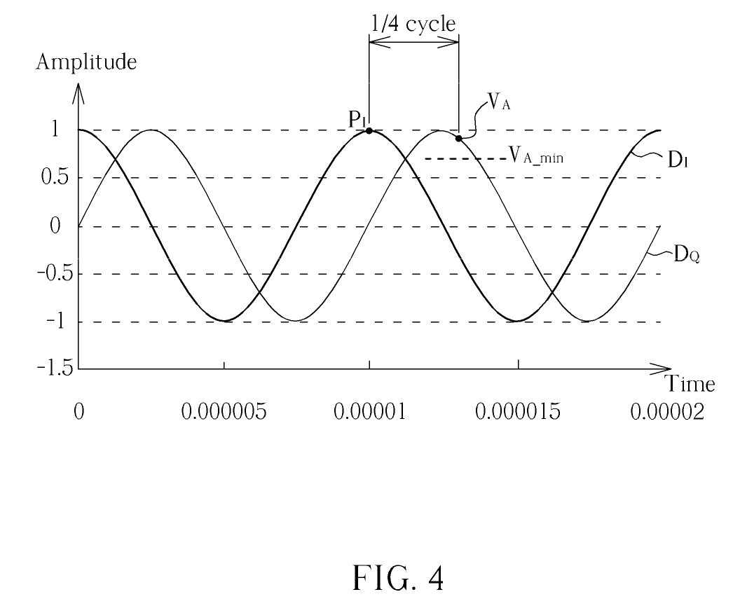

Regarding the operations of the apparatus 330, please refer to FIG. 3A and FIG. 4 together. FIG. 4 is an auxiliary diagram for explaining a determination of the phase difference information between the digitized I signal D_{I} and the digitized Q signal D_{Q} shown in FIG. 3A. The first detector 332 receives and detects a peak P_{I} of the digitized I signal D_{I}, and when the peak P_{I} is detected, the first detector 332 sends an enable signal V_{EN} to enable the counter 336 to start using a reference clock CLK to count a timing so as to generate a counter value. Then, when the counter value reaches a predetermined counter value, the counter 336 sends a trigger signal V_{TR} to trigger the second detector 334 to detect a value V_{A} of the digitized Q signal D_{Q}, where the predetermined counter value can be regarded as a predetermined time. In this embodiment, the predetermined counter value is set to be regarded as the predetermined time equal to a quarter cycle time of the digitized I signal D_{I} or the digitized Q signal D_{Q}. In response to the trigger signal V_{TR}, the second detector 334 outputs the value V_{A} of the digitized Q signal D_{Q} to the determination unit 338, and the determination unit 338 determines whether a phase difference between the digitized I signal D_{I} and the digitized Q signal D_{Q} meets an exemplary specific criterion by checking if the value V_{A} of the digitized Q signal D_{Q} is within a predetermined range or is greater or lower than a threshold value, thereby generating the phase difference information.

For example, if the predetermined counter value is regarded as a quarter cycle time of the digitized I signal D_{I} or the digitized Q signal D_{Q}, the value V_{A} of the digitized Q signal D_{Q} ideally should be a peak value if there is no phase-shift. Therefore, a threshold value V_{A}_{_{—}}ₘᵢₙ can be set as shown in FIG. 4, and the detected values greater than the threshold value V_{A}_{_{—}}ₘᵢₙ are defined as that the phase difference between the digitized I signal D_{I} and the digitized Q signal D_{Q} meets the exemplary specific criterion. The determination unit 338 is arranged to determine whether the value V_{A} is greater than the threshold value V_{A}_{_{—}}ₘᵢₙ. When the value V_{A} of the digitized Q signal D_{Q} is greater than the threshold value V_{A}_{_{—}}ₘᵢₙ, the phase difference information indicates that the phase difference between the digitized I signal D_{I} and the digitized Q signal D_{Q} meets the exemplary specific criterion; and when the value V_{A} of the digitized Q signal D_{Q} is not greater than the threshold value V_{A}_{_{—}}ₘᵢₙ, the phase difference information indicates that the phase difference between the digitized I signal D_{I} and the digitized Q signal D_{Q} does not meet the exemplary specific criterion.

It is noted that, the peak P_{I} shown in FIG. 4 is a higher peak of the digitized I signal D_{I}, in another embodiment, the peak P_{I} can also be a lower peak of the digitized I signal D_{I}. In this another embodiment, the determination unit 338 could be designed as when the value V_{A} of the digitized Q signal D_{Q} is less than another threshold value, the phase difference information indicates that the phase difference between the digitized I signal D_{I} and the digitized Q signal D_{Q} meets the exemplary specific criterion; and when the value V_{A} of the digitized Q signal D_{Q} is not less than the threshold value, the phase difference information indicates that the phase difference between the digitized I signal D_{I} and the digitized Q signal D_{Q} does not meet the exemplary specific criterion.

It is further noted that, in the communication receiver 300 shown in FIG. 3A, the apparatus 330 determines whether the phase difference between the digitized I signal D_{I} and the digitized Q signal D_{Q} meets the specific criterion. In other embodiments of the present invention, the apparatus 330 can receive other I and Q signals from the I-channel and the Q-channel before the ADCs 316 and 326, such as the filtered I signal outputted from the filter 314 and the filtered Q signal outputted from the filter 324, to determine phase difference information indicative of a phase difference between two analog signals, e.g., the filtered I and Q signals.

In addition, in a fourth embodiment of the present invention as shown in FIG. 3B, the value V_{A} of the digitized Q signal D_{Q} can directly serve as the phase difference information which is determined by the apparatus 330. That is, the determination unit 338 can be removed from the apparatus 330 without influencing the operations of the apparatus 330. The components of a communication receiver 400 and the communication receiver 300 with the same symbols have the same functions. A person skilled in this art can understand the operations of the communication receiver 400 shown in FIG. 3B after studying the above disclosure, and the descriptions of the operations of the communication receiver 400 are therefore omitted here.

In addition, in the apparatus 330, the first detector 332 is used to detect the peak P_{I} of the digitized I signal D_{I}. However, the detected target of the detector 332 is not limited to the peak as illustrated in this embodiment, that is, other detectable values of the communicated signal, such as the zero crossing point or the point of a half amplitude, could be selected as the target the detector 332 designed to detect. For example, the determination unit 338 may determine whether a phase difference between the digitized I signal D_{I} and the digitized Q signal D_{Q} meets a specific criterion by checking if the value V_{A} of the digitized Q signal D_{Q} is within a predetermined range. More particularly, when the first detector 332 detects the zero crossing point of the digitized I signal D_{I}, and the predetermined counter value is regarded as a quarter cycle time, the value detected by the second detector 324 should also be close to the zero crossing point if there is no phase-shift. Therefore, a predetermined range can be set from −0.1 to 0.1. When the value V_{A} of the digitized Q signal D_{Q} is within the predetermined range (i.e. −0.1<V_{A}<0.1), the phase difference information indicates that the phase difference between the digitized I signal D_{I} and the digitized Q signal D_{Q} meets the exemplary specific criterion; and when the value V_{A} of the digitized Q signal D_{Q} is out of the predetermined range (i.e., V_{A}>0.1 or V_{A}<−0.1), the phase difference information indicates that the phase difference between the digitized I signal D_{I} and the digitized Q signal D_{Q} does not meet the exemplary specific criterion.

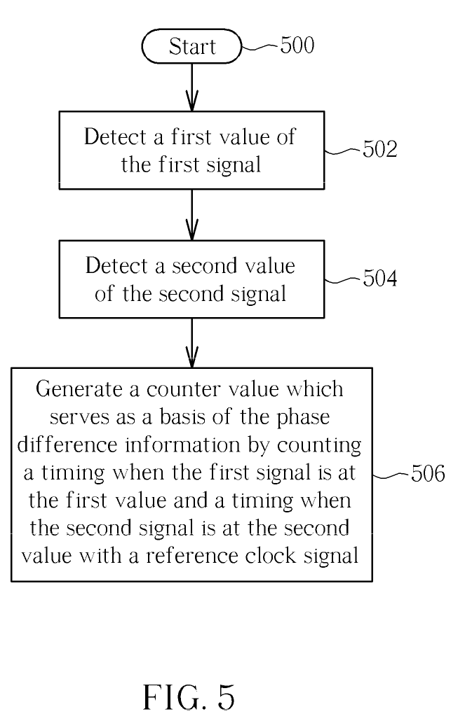

Please refer to FIG. 5. FIG. 5 is a simplified flowchart of determining phase difference information between a first signal and a second signal according to one embodiment of the present invention. It is noted, provided the result is substantially the same, the steps are not limited to be executed according to the exact order shown in FIG. 5. Referring to the flowchart shown in FIG. 5, the operations of writing the encoded data into the storage medium are as follows:

Step 500: start.

Step 502: detect a first value of the first signal.

Step 504: detect a second value of the second signal.

Step 506: generate a counter value which serves as a basis of the phase difference information by counting a timing when the first signal is at the first value and a timing when the second signal is at the second value with a reference clock signal.

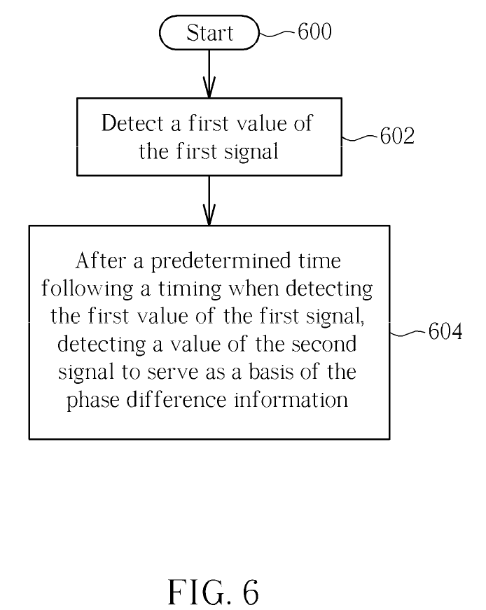

In addition, please refer to FIG. 6. FIG. 6 is a simplified flowchart of determining phase difference information between a first signal and a second signal according to another embodiment of the present invention. It is noted, provided the result is substantially the same, the steps are not limited to be executed according to the exact order shown in FIG. 6. Referring to the flowchart shown in FIG. 6, the operations of writing the encoded data into the storage medium are as follows:

Step 600: start.

Step 602: detect a first value of the first signal.

Step 604: after a predetermined time following a timing when detecting the first value of the first signal, detecting a value of the second signal to serve as a basis of the phase difference information.

Briefly summarized, in the apparatus and method of the present invention, a phase difference between I and Q signals can be correctly obtained, and whether a phase difference between the first and the second signals meets a specific criterion can also be determined.

Those skilled in the art will readily observe that numerous modifications and alterations of the device and method may be made while retaining the teachings of the invention.

What is claimed is:

1. An apparatus for determining phase difference information between a first signal and a second signal, comprising:
a first detector, for detecting a first value of the first signal;
a second detector, for detecting a second value of the second signal; and
a counter, for counting a timing when the first signal is at the first value and a timing when the second signal is at the second value with a reference clock signal to generate a counter value which serves as a basis of the phase difference information.

2. The apparatus of claim 1, wherein the counter is arranged to output the counter value to directly serve as the phase difference information determined by the apparatus.

3. The apparatus of claim 1, further comprising:
a determination unit, for determining whether a phase difference between the first and the second signals meets a specific criterion by checking if the counter value is within a predetermined range, thereby generating the phase difference information.

4. The apparatus of claim 1, wherein the first and the second signals are from an I-channel and a Q-channel, respectively, of a receiver in a communication system.

5. A method for determining phase difference information between a first signal and a second signal, comprising:
detecting a first value of the first signal;
detecting a second value of the second signal; and
generating a counter value which serves as a basis of the phase difference information by counting a timing when the first signal is at the first value and a timing when the second signal is at the second value with a reference clock signal.

6. The method of claim 5, further comprising:
outputting the counter value to directly serve as the phase difference information.

7. The method of claim 5, further comprising:
determining whether a phase difference between the first and the second signals meets a specific criterion by checking if the counter value is within a predetermined range, thereby generating the phase difference information.

8. The method of claim 5, wherein the first and the second signals are from an I-channel and a Q-channel, respectively, of a receiver in a communication system.

9. An apparatus for determining phase difference information between a first signal and a second signal, comprising:
a first detector, for detecting a first value of the first signal; and
a second detector, wherein after a predetermined time following a timing when the first detector detects the first value of the first signal, the second detector is arranged to detect a value of the second signal to serve as a basis of the phase difference information.

10. The apparatus of claim 9, further comprising:
a counter, for generating a counter value by a reference clock signal, and triggering the second detector to detect the value of the second signal when the counter value reaches a predetermined counter value representative of the predetermined time.

11. The apparatus of claim 9, wherein the second detector outputs the value of the second signal to directly serve as the phase difference information determined by the apparatus.

12. The apparatus of claim 9, further comprising:
a determination unit, for determining whether a phase difference between the first and the second signals meets a specific criterion by checking if the value of the second signal is within a predetermined range or is greater or less than a threshold value, thereby generating the phase difference information.

13. The apparatus of claim 9, wherein the first and the second signals are from an I-channel and a Q-channel, respectively, of a receiver in a communication system.

14. A method for determining phase difference information between a first signal and a second signal, comprising:
detecting a first value of the first signal; and
after a predetermined time following a timing when detecting the first value of the first signal, detecting a value of the second signal to serve as a basis of the phase difference information.

15. The method of claim 14, wherein the step of detecting the value of the second signal further comprises:
generating a counter value by a reference clock signal, and detecting the value of the second signal when the counter value reaches a predetermined counter value representative of the predetermined time.

16. The method of claim 14, further comprising:
outputting the value of the second signal to directly serve as the phase difference information.

17. The method of claim 14, further comprising:
determining whether a phase difference between the first and the second signals meets a specific criterion by checking if the value of the second signal is within a predetermined range or is greater or less than a threshold value, thereby generating the phase difference information.

18. The method of claim 14, wherein the first and the second signals are from an I-channel and a Q-channel, respectively, of a receiver in a communication system.
